(19) United States
(12) Patent Application Publication
(10) Pub. No.: US 2020/0207196 A1
(43) Pub. Date: Jul. 2, 2020

(54) Releasable Seal Assembly for Emergency Access and Egress

(71) Applicant: Westinghouse Air Brake Technologies Corporation, Wilmerding, PA (US)

(72) Inventors: Christopher Vu, Laval (CA); Fabien Vautier, Veretz (FR); Olivier Salles, Lecousse (FR)

(21) Appl. No.: 16/235,285

(22) Filed: Dec. 28, 2018

(51) Int. Cl. B60J 10/36; B60J 10/84; B60J 10/27; F16J 15/02

(52) U.S. Cl. CPC B60J 10/36; F16J 15/022; B60J 10/27; B60J 10/84

(57) ABSTRACT

A removal seal for emergency access and egress for panels in transit vehicles has a pair of exit panel side wings separated by two key cavities. A locking strip is inserted within the two key cavities to urge the exit panel side wings against the exit panel to secure the exit panel. The locking strip may then be removed with relative ease such that the exit panel may be freed from the exit panel side wings and released. A method for achieving such a task is also disclosed herein.

### BACKGROUND OF THE INVENTION

### Field of the Invention

The invention relates to a panel mounting arrangement such as a removeable glass panel in a passenger rail car vestibule door.

### Description of Related Art

New United States regulation 49 CFR § 238.112 titled “Door Emergency Egress and Rescue Access System” requires the installation of a removeable panel in passenger rail car vestibule doors. The removal process must be executable with the application of a reasonable force by passengers and emergency first responders. The seal components must also be sufficiently strong to withstand multiple disassembly and reassembly for testing purposes. For some applications, the seal must be water tight.

Existing zip strip seals do not give any consideration to panel removal pull force. For currently existing applications, the zip strip seal assembly/disassembly duty cycle is not a design consideration. They are therefore not designed to hold and facilitate multiple installation and removal.

FIG. 1 illustrates a well-known rubber seal device wherein an exit panel 1, such as a window pane of glass, is surrounded by a rubber seal 2 which fills the void between the exit panel and the window frame. The rubber seal 2 is installed around the window opening of a host panel 3 and then the exit panel 1 is secured to the rubber seal 2. A channel is provided in the rubber seal 2 to allow for the insertion of a locking strip which locks the rubber seal 2 in place.

Several patents describe various implementations of rubber seals with locking strips, such as U.S. Pat. Nos. 4,621,469, 4,458,459, 4,483,113, French Patent No. 2,952,900 A1, and French Patent No. 2,431,644 A1. Additionally, some known arrangements in the transit industry are meant to be disassembled in case of emergency to allow for egress and access into a confined area such as a transit vehicle.

A design is needed that provides for multiple disassembly and assembly while at the same time allowing such disassembly with a reasonable force.

### SUMMARY OF THE INVENTION

A releasable seal assembly for securing an exit panel having opposing walls with a thickness therebetween to a host panel. The assembly has a seal with a first extension profile and a second extension profile extending from a core defining an exit panel slot therebetween. The core is disposed along a first axis of the seal and extends across the width of the seal. Each of the first extension profile and the second extension profile has an exit panel side wing on one side of the slot. Each side wing is resiliently hinged to the core in a relaxed position away from the slot, has a panel side facing the slot, and has an opposing cavity side defining a key cavity between the side wing and the core. The assembly also has a locking strip associated with the respective first and second extension profiles.

In a first state for each of the first extension profile and the second extension profile, the locking strip is positioned within the key cavity of both extension profiles such that the side wings are resiliently displaced to a first biased position to secure the exit panel within the slot. In a second state, at least one locking strip is removed from the key cavity of an extension profile and at least one side wing is returned to the relaxed position away from the slot such that the exit panel may be removed from the slot.

A second embodiment is directed to a method for releasing an exit panel from a host panel using the seal assembly described herein wherein the locking strip is secured within the key cavity. The method is made up of the steps of removing the locking strip from the key cavity such that the exit panel wing moves to the relaxed position and then removing the exit panel from the seal.

### BRIEF DESCRIPTION OF THE DRAWINGS

FIG. 1 is prior art and discloses a seal arrangement wherein the seal may be assembled/disassembled only a few times;

FIG. 2 is a representative door or side of a transit vehicle having an exit panel mounted to a host panel using a seal assembly in accordance with the subject invention;

FIG. 3 is a view along arrows “3-3” in FIG. 2;

FIG. 4 is a view along arrows “4-4” in FIG. 2;

FIG. 5 is a cross-sectional view of a resilient seal in accordance with the subject invention;

FIG. 6 is a cross-sectional view of a locking strip in accordance with the subject invention;

FIG. 7 is a cross-sectional view of the seal with the locking strip secured within the key cavity; and

FIGS. 8 and 9 are cross-sectional views of the seal showing the range of motion of an exit panel side wing.

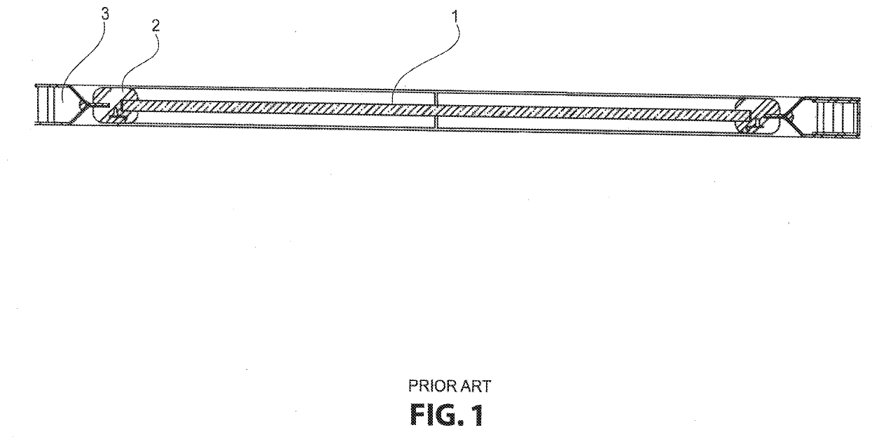

### DESCRIPTION OF THE INVENTION

One or more of the following benefits may be available in accordance with the subject invention:

a) The capability of disassembly of the seal from both sides of a removeable panel or window.

b) Ease of operability, which may permit rapid and easy removal from each side of a door during an emergency situation without requiring the use of a tool or other implement. In particular, the force required to remove the panel (or window) is substantially lower than for a traditional zip strip seal.

c) For testability, the device can be repeatedly assembled/disassembled without damage and loss of function.

d) Once in place with the locking strip, the seal arrangement provides significant panel retention so that a relatively high force applied on the exit panel through, for example, a foot kick, does not cause the panel to pop out of the host door panel.

e) The arrangement provides a minimum cross-section thickness once in place to accommodate pocket door applications where seal protrusion over the outer main surface of the door panel should be minimized.

The device may provide an optional water tight seal for applications involving one side of the assembly exposed to the environment.

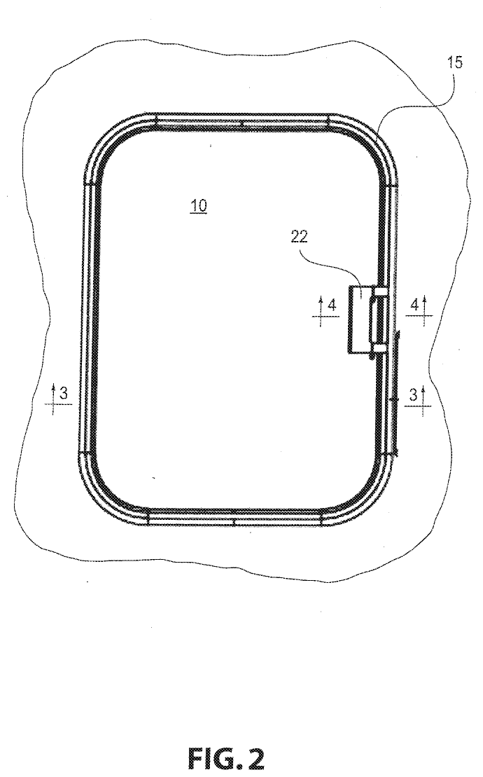

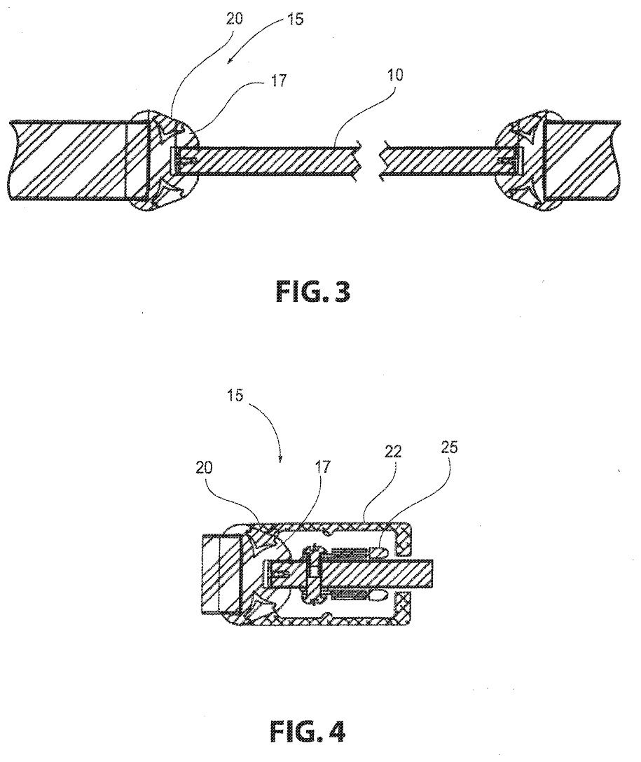

Directing attention to FIGS. 2-4, an exit panel 10 is surrounded by a seal assembly 15 made up of a resilient seal 17 and a locking strip 20. As will be further discussed, the locking strip 20 is inserted into the seal 17.

Although not part of the subject invention, a typical arrangement for releasing the seal 17 discussed herein, along with other seals, involves, as illustrated in FIG. 4, the use of a handle 22 secured to the locking strip 20 such that when the handle 22 is pulled, the locking strip 20 is removed from the seal 17 and the exit panel 10 is removed. The handle 22 also conceals a wire rope lanyard 25 which is secured to the exit panel 10, thus, allowing the removal of the exit panel 10 by pulling on the handle 22/lanyard 25. This arrangement is known by those skilled in the art.

The locking strip 20 pull force is controlled by the specific shape of the key and the main key cavity as well as the materials of the seal and locking strip. Also, a low key pull force is obtained relatively easily utilizing the subject design by providing short retention tongues on both sides of the key cross-section profile. In prior art designs, the ability to provide a low pull force for the exit panel, once the locking strip is removed all around the perimeter of the exit panel, is diminished because the panel side wings do not move sufficiently away from the exit panel. As a result, the wings partially block the exit panel and impede the ability to easily remove the panel. However, the seal in accordance with the subject invention allows the panel side wings to rotate significantly further than prior art designs to permit removal of the panel with less interference from the panel side wings.

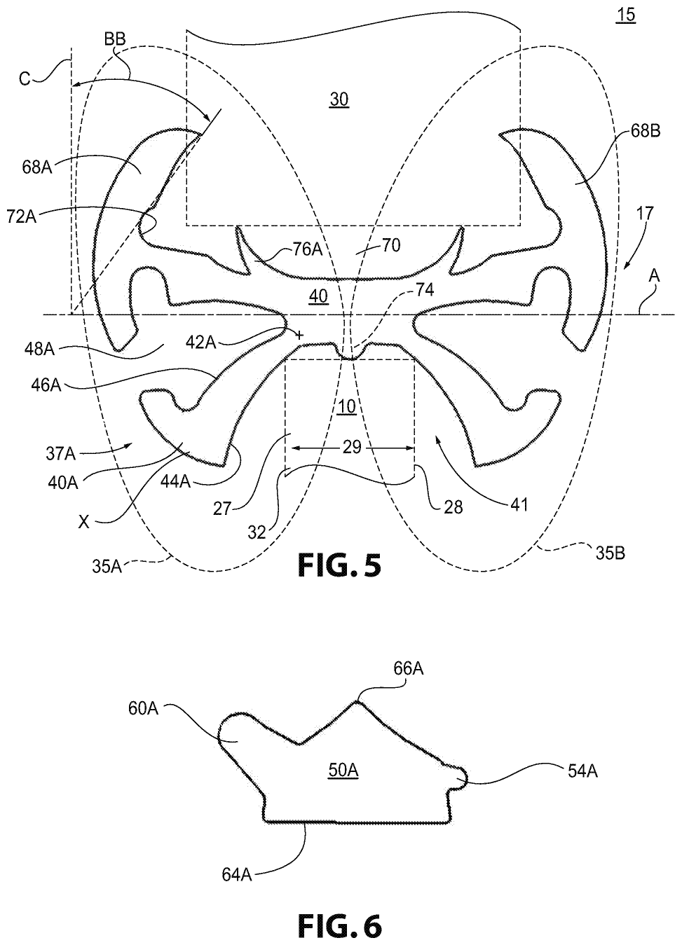

Directing attention to FIG. 5, a seal assembly 15 for removably securing an exit panel 10 is illustrated in phantom having opposing walls 27, 28 with a thickness 29 therebetween, to a host panel 30 also shown in phantom.

The seal 17 has a first extension profile 35A and a second extension profile 35B extending from a core 40 defining an exit panel slot 41 therebetween. The core 40 is disposed along a first axis A of the seal 17 and extends across the width of the seal 17.

For purposes of discussion, components associated with the first extension profile 35A will utilize a suffix “A”, while those associated with a second extension profile 35B will use a suffix “B”. The first extension profile will be discussed with the understanding that the second extension profile features are identical and disposed symmetrically with respect to an axis at a right angle from the core 40 first axis A and passing through the center of the core 40.

Directing attention to FIG. 5, the first extension profile 35A is made up of an exit panel side wing 40A on one side of the slot 41. The side wing 40A is resiliently hinged about a pivot point 42A to the core 40 in a relaxed position X away from the slot 41, as illustrated in FIG. 5. The side wing 40A has a panel side 44A facing the slot 41 and has an opposing cavity side 46A. The side wing 40A also defines a key cavity 48A between the side wing 40A and the core 40.

FIG. 5 illustrates the exit panel side wing 40A in a relaxed position X whereby the exit panel 10 is not restrained and is free to be removed from the slot 41.

Directing attention to FIGS. 6-8, a locking strip 50A is shown in position within the key cavity 48A. It should be appreciated that with the locking strip 50A inserted within the key cavity 48A, the exit panel side wing 40A is displaced from a relaxed position X illustrated in FIG. 5 to a first biased position Y where it is urged against the exit panel 10.

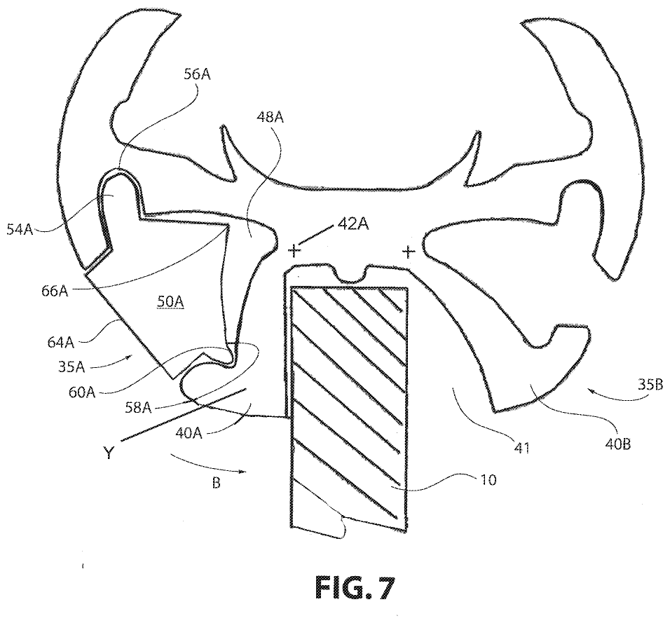

In particular, the locking strip 50A in FIG. 7 is positioned within the key cavity 48A of the first extension profile 35A such that the side wing 40A is resiliently displaced about the pivot point 42A and the side wing 40A extends against the edge of the exit panel 10 within the slot 41. When both the first extension profile 35A and the second extension profile 35B assume this configuration, then the exit panel 10 is securely retained within slot 41 of the seal 17.

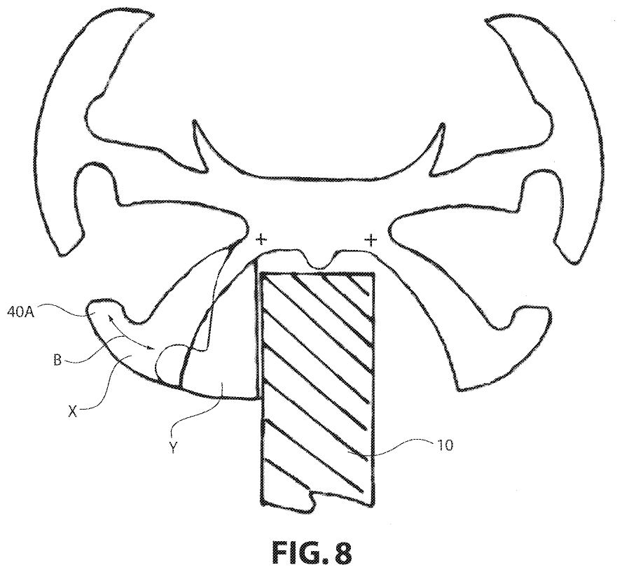

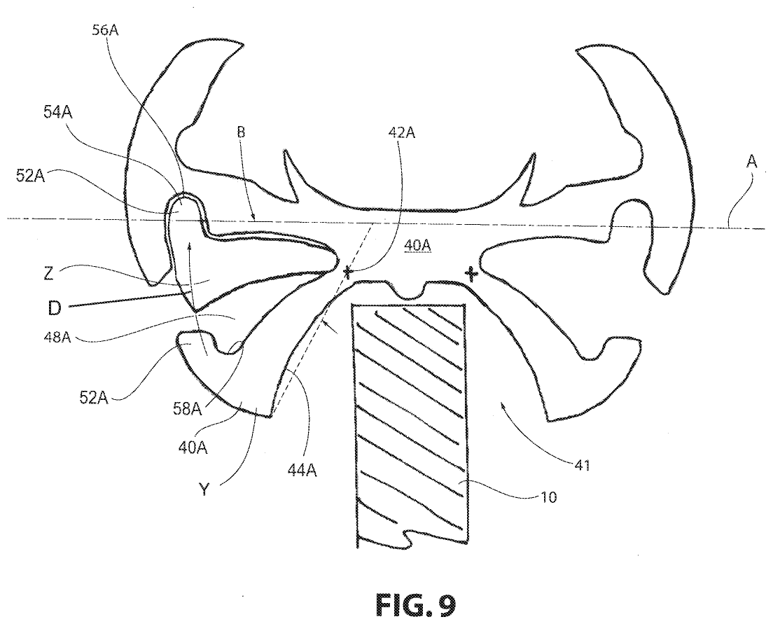

Directing attention to FIGS. 8 and 9, when the locking strip 50A is removed from the key cavity 48A, the exit panel side wing 40A returns from the first biased position Y to the relaxed position X with the exit panel 10 free to be removed from the slot 41. In particular, from the first biased position Y, with the locking strip 50A removed from the key cavity 48A of the first extension profile 35A, the side wing 40A is returned to the relaxed position X away from the slot 41 such that the exit panel 10 may be removed from the slot 41. As illustrated in FIG. 9, in the relaxed position X the panel side 44A of the exit panel side wing 40A forms an angle B with a maximum value substantially equal to 60 degrees with respect to axis A to allow for the easy removal of the exit panel 10.

However, directing attention again to FIG. 9, it should be appreciated that upon lateral removal of the exit panel 10, the exit panel 10 may further displace the exit panel side wing 40A to a second biased position Z. Again, directing attention to FIG. 9, the exit panel side wing 40A has a wing tip 52A which moves along an arc of the hinge defined by the pivot point 42A. The core 40 includes a first retention tongue recess 56A to accept the wing tip 52A such that when the exit panel side wing 40A is rotated by the exit panel 10 away from the slot 41 to the second biased position Z in a rotation direction D, the exit panel side wing 40A substantially mates with the first retention tongue recess 56A thereby providing full clearance to remove the exit panel 10 in a lateral direction.

What has just been described is the exit panel side wing 40A rotated into the first retention tongue recess 56A.

Returning to FIG. 7, the exit panel side wing 40A further includes a second retention tongue recess 58A facing the key cavity 48A. A first retention tongue 54A and a second retention tongue 60A are used to engage the locking strip 50A. The locking strip 50A has a cross-section with the first retention tongue 54A and the second retention tongue 60A positioned such that when the locking strip 50A is located within the expanded key cavity 48A, the first retention tongue 54A engages the first retention tongue recess 56A and the second retention tongue 60A engages the second retention tongue recess 58A to retain the locking strip 50A within the key cavity 48A.

Directing attention to FIGS. 6 and 7, the locking strip 50A further includes a generally flat portion 64A and a key wedge 66A disposed opposite to the flat segment 64A and between the first retention tongue 54A and the second retention tongue 60A. As illustrated in FIG. 7, when the locking strip 50A is positioned within the key cavity 48A, the flat segment 64A is generally flush with an exterior surface of the seal 17.

Directing attention to FIG. 5, the first extension profile 35A further includes a host panel side wing 68A joined to the core 40 on the core side opposite to the exit panel side wing 40A. The host panel side wing 68A is disposed at an angle BB with respect to a second axis C, wherein the second axis C forms a right angle with the first axis A. The angle BB may be measured from the tip 69A of and along the face of the host panel side wing 68A and is intended to ensure that the host panel side wing 68A is able to resiliently clamp the host panel 30 when the host panel 30 is placed within a host panel slot 70 formed by the pair of host panel side wings 68A, 68B.

As illustrated in FIG. 5, the host panel side wing 68A includes a stress relief recess 72A at its junction with the core 40 wherein the stress relief recess may be semicircular. Furthermore, the seal 17 adjacent to the exit panel slot 41 may include a protrusion 74 extending from the cavity 40 at the base of the slot 41 on the side of the core 40 adjacent to the exit panel side wing 40A. This protrusion 74 may be semicircular and is intended to provide a lower friction surface between the seal and the edge of the exit panel, thus, lowering the panel extraction force.

Again, returning to FIG. 5, at least one lip 76 may extend from the base of the host panel slot 70 of the host panel 30 to contact the host panel 30 to provide a waterproof seal.

It should be noted from an inspection of FIG. 5 that the seal 17 may be symmetric about an axis at a right angle from the core 40 first axis A and passing through the center of the core 40.

The seal 17 may be made of resilient material such as EPDM, neoprene, or silicon while the preferred material is neoprene. Furthermore, the seal should preferably have a hardness of about 70 Shore. The locking strip 50A may be of a similar material and have similar properties.

While so far discussed are both a first extension profile 35A and a second extension profile 35B having key cavities, it is entirely possible for one of these key cavities to be eliminated such that that region of one of the exit panel side wing/key cavity combinations is essentially solid. Under these circumstances, only a single exit panel side wing would be utilized to release the exit panel 10 and the exit panel 10 would then only be able to be removed from a single direction.

Finally, the subject invention may be directed to a method for releasing an exit panel 10 from a host panel 30 using a seal 17 as described herein wherein the locking strip 50A is secured within the key cavity 48A wherein the method comprises the steps of removing the locking strip 50A from the key cavity 48A such that the exit panel side wing 40A moves to the relaxed position and, thereafter, removing the exit panel 10 from the seal such that the exit panel 10 displaces the exit panel side wing 40A up to a point where the first retention tongue 54A engages the first retention tongue recess 56A.

While certain embodiments of the invention are shown in the accompanying figures and described herein above in detail, other embodiments will be apparent to and readily made by those skilled in the art without departing from the scope and spirit of the invention. For example, it is to be understood that this disclosure contemplates that to the extent possible, one or more features of any embodiment can be combined with one or more features of the other embodiment.

Accordingly, the foregoing description is intended to be illustrative rather than restrictive.

1. A releasable seal assembly comprising:
a core disposed along a first axis of a seal and extending across a width of the seal;
a first extension profile extending from the core and having a first side wing resiliently hinged to the core; and
a second extension profile extending from a core and having a second side wing resiliently hinged to the core;
the first extension profile and the second extension profile defining an exit panel slot therebetween; and
the first side wing at least partially defining a first key cavity within the core that is configured to receive a first locking strip that is configured to bias the first side wing from a relaxed position, in the relaxed position the first side wing compared to the first axis of the seal forms a first angle that is less than 90 degrees. to a first biased position to secure the exit panel within the slot.

2. The seal assembly in accordance with claim 1, wherein the first angle is equal to or less than 60 degrees with the first axis.

3. The seal assembly in accordance with claim 1, wherein the first side wing has a tip with a first retention tongue extending along an arc of the first extension profile, and wherein the core further includes a first retention tongue recess to accept the first retention tongue such that when the first side wing is rotated in a rotation direction the first locking strip mates with the first retention tongue recess.

4. The seal assembly in accordance with claim 3, wherein the first side wing further includes a first side wing tongue recess facing the first key cavity, and wherein the first locking strip has a cross-section with a first locking strip retention tongue and a second locking strip retention tongue positioned such that when the first locking strip is located within the expanded first key cavity, the first locking strip retention tongue engages the first side wing tongue recess and the second locking strip retention tongue engages a second retention tongue recess of the core to retain the first locking strip within the first key cavity.

5. The seal assembly in accordance with claim 4, wherein the first locking strip further includes a flat segment and a key wedge, wherein the flat segment is disposed between the first locking strip retention tongue and second locking strip retention tongue and the key wedge is disposed opposite to the flat segment and between the first locking strip retention tongue and second locking strip retention tongue.

6. The seal assembly in accordance with claim 5, wherein when the first locking strip is positioned within the first key cavity, and the flat segment of the first locking strip is flush with an exterior surface of the seal.

7. The seal assembly in accordance with claim 1, wherein the first extension profile further comprises at least one host panel side wing extending from the core and disposed at an angle with respect to a second axis, wherein the second axis is at a right angle from the first axis.

8. (canceled)

9. The seal assembly in accordance with claim 1, wherein the seal further comprises a protrusion extending from a base of the exit panel slot.

10. The seal assembly according to claim 9, wherein the protrusion is semicircular.

11. The seal assembly in accordance with claim 1, further comprising at least one lip extending from a base of a host panel slot within the core and configured to contact the host panel to provide a waterproof seal.

12. The seal assembly in accordance with claim 1, wherein the seal assembly is symmetric about second axis at a right angle from the first axis and passing through the center of the core.

13. The seal assembly in accordance with claim 1, wherein the resilient seal is made of a material of at least one of EPDM, neoprene, or silicone.

14. The seal assembly in accordance with claim 1, wherein the seal has a hardness of about 70 Shore.

15. A seal assembly for removably securing an exit panel to a host panel, wherein the seal assembly comprises:
a first extension profile and a second extension profile extending from a core of a seal and disposed along a first axis of the seal; an exit panel slot defined within the core adjacent the first extension profile; wherein the first extension profile has a first side wing on one side of the exit panel slot that is resiliently hinged to the core and in a relaxed position angled away from the slot, wherein a key cavity is defined within the core adjacent the first side wing; and
a locking strip,
wherein for the first extension profile, in a first state the locking strip is positioned within the key cavity of the core such that the first side wing in a first biased position secures the exit panel within the exit panel slot; and
wherein in a second state, the locking strip is removed from the key cavity of the core and the first side wing returns to the relaxed position such that the exit panel may be removed from the exit panel slot.

16. A method for releasing an exit panel from a host panel using the seal in accordance with claim 1, wherein the locking strip is secured to the seal comprising:
removing the first locking strip from the key cavity such that the first side wing moves to the relaxed position; and
b) removing the exit panel from the core, wherein pulling on the exit panel causes rotation of the first side wing about a pivot point until a tip of a first retention tongue mates with a first retention tongue recess allowing the exit panel to be removed from the exit panel slot.

17. The seal assembly of claim 15, wherein in a relaxed position the angle of the first side wing to the first axis is equal to or less than 60 degrees.

18. The seal assembly in accordance with claim 15, wherein the first side wing has a tip with a first retention tongue extending along an arc of the hinge of the first extension profile, and wherein the core further includes a first retention tongue recess to accept the first retention tongue such that when the first side wing is rotated in a rotation direction the first locking strip mates with the first retention tongue recess in a second biased position.

19. The seal assembly in accordance with claim 15, wherein the first extension profile further comprises at least one host panel side wing extending from the core and disposed at an angle with respect to a second axis, wherein the second axis is at a right angle from the first axis.

20. The seal assembly in accordance with claim 15, wherein the seal further comprises a protrusion extending from a base of the exit panel slot.
